(19) United States
(12) Patent Application Publication
(10) Pub. No.: US 2024/0356103 A1
(43) Pub. Date: Oct. 24, 2024

(54) BATTERY PACK

(71) Applicant: HYUNDAI MOBIS CO., LTD., Seoul (KR)

(72) Inventor: Young Chan YOON, Yongin-si (KR)

(73) Assignee: HYUNDAI MOBIS CO., LTD., Seoul (KR)

(21) Appl. No.: 18/137,499

(22) Filed: Apr. 21, 2023

(51) Int. Cl. H01M 10/6556; H01M 10/613

(52) U.S. Cl. CPC H01M 10/6556; H01M 10/613

(57) ABSTRACT

Disclosed is a battery pack including a laminate including a plurality of electrode assemblies each having a structure in which an electrode and a separation membrane are alternately arranged, the plurality of electrode assemblies being laminated in a first direction, an accommodation member having an inner space in which the laminate is accommodated and including an inlet provided on one side thereof, through which a cooling fluid is introduced, and an outlet provided on another side thereof, through which the cooling fluid is discharged, the another side opposing the one side in a second direction crossing the first direction, and a distribution member that is spaced from the laminate in a third direction crossing the first direction and the second direction and changes a flow direction of the cooling fluid, wherein the distribution member has a shape extending in the one direction.

### TECHNICAL FIELD

The present disclosure relates to a battery pack, and more particularly, to a battery pack that is provided to be coolable.

### BACKGROUND

To ensure the performance and stability of a battery pack mounted on an electric vehicle or the like, it is required to effectively cool components of the battery pack. For example, to implement high-speed driving of the electric vehicle equipped with the battery pack, since a large amount of current is required as compared to normal driving conditions, heat generation of the battery pack also greatly increases, and thus it is essential to effectively cool the battery pack.

To effectively cool the above-described battery pack, according to the related art, an immersion cooling method is used in which a cooling fluid having electrical insulation is directly brought into contact with an electrode assembly provided in the battery pack. In more detail, the battery pack includes a plurality of battery modules, and immersion cooling is performed by supplying the cooling fluid to each battery module.

However, according to the related art, to implement the immersion cooling, each battery module requires an airtight case and components required for the immersion cooling. Thus, manufacturing costs of the battery pack in which the immersion cooling may be performed increases, and the size of the battery pack also increases.

### SUMMARY

The present disclosure has been made to solve the above-mentioned problems occurring in the prior art while advantages achieved by the prior art are maintained intact.

An aspect of the present disclosure provides a battery pack having a novel structure, which may implement immersion cooling without configuring a plurality of battery modules.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, battery pack includes a laminate including a plurality of electrode assemblies each having a structure in which an electrode and a separation membrane are alternately arranged, the plurality of electrode assemblies being laminated in a first direction, an accommodation member having an inner space in which the laminate is accommodated and including an inlet provided on one side thereof, through which a cooling fluid is introduced, and an outlet provided on another side thereof, through which the cooling fluid is discharged, the another side opposing the one side in a second direction crossing the first direction and a distribution member that is spaced from the laminate in a third direction crossing the first direction and the second direction and changes a flow direction of the cooling fluid, wherein the distribution member has a shape extending in the one direction.

The accommodation member may have an open upper area, the battery pack may further include an upper cover that is coupled to the accommodation member and covers the upper area, and the distribution member may include an upper distribution member fixed to a lower surface of the upper cover and protruding downward towards the laminate.

The accommodation member may have an open lower area, the battery pack may further include a lower cover that is coupled to the accommodation member and covers the lower area, and the distribution member may include a lower distribution member fixed to an upper surface of the lower cover and protruding upward towards the laminate.

The distribution member may be provided as a plurality of distribution members, and the plurality of distribution members may be spaced apart from each other in the second direction.

In a second direction-third direction cross-section, the distribution member may have a triangular shape.

In a second direction-third direction cross-section, the distribution member may have a quadrangular shape.

In a second direction-third direction cross-section, the distribution member may have a shape in which a width in the second direction decreases in a direction towards the laminate.

In a second direction-third direction cross-section, the distribution member may have a shape in which a width in the second direction is constant.

In a second direction-third direction cross-section, the distribution member may include a curved surface convexly protruding in the second direction.

The inlet and the outlet may be provided at a center of the accommodation member in the first direction, and a ratio s/L of an interval “s” between the plurality of distribution members in the second direction to a length “L” of the upper cover or the lower cover in the second direction may be 0.02 or more and 0.24 or less.

The inlet may be provided at a position at which a ratio of a distance from one end of the accommodation member in the first direction to a distance from the other end thereof in the first direction is 1:5, the outlet may be provided at a position at which a ratio of the distance from the one end of the accommodation member in the first direction to the distance from the other end thereof in the first direction is 5:1, and a ratio s/L of an interval “s” between the plurality of distribution members in the second direction to a length “L” of the upper cover or the lower cover in the second direction may be 0.02 or more and 0.20 or less.

The inlet and the outlet may be provided at a position at which a ratio of a distance from one end of the accommodation member in the first direction to a distance from the other end thereof in the first direction is 1:5, and a ratio s/L of an interval “s” between the plurality of distribution members in the second direction to a length “L” of the upper cover or the lower cover in the second direction may be 0.02 or more and 0.17 or less.

The inlet may be provided at a position at which a ratio of a distance from one end of the accommodation member in the first direction to a distance from the other end thereof in the first direction is 1:5, the outlet may be provided at a center of the accommodation member in the first direction, and a ratio s/L of an interval “s” between the plurality of distribution members in the second direction to a length “L” of the upper cover or the lower cover in the second direction is 0.02 or more and 0.24 or less.

The upper cover and the upper distribution member may be integral.

The lower cover and the lower distribution member may be integral.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a structure of a battery pack according to the present disclosure;

FIG. 2 is a perspective view illustrating a state in which an upper cover and a lower cover are vertically spaced apart from an accommodation member in the battery pack according to the present disclosure;

FIG. 3 is a cross-sectional view illustrating examples of a shape of a distribution member provided in the battery pack according to the present disclosure;

FIG. 4 is a plan view illustrating an upper cover, a lower cover, and a distribution member of a battery pack according to a first example of the present disclosure;

FIG. 5 is a view illustrating a temperature distribution of a cooling fluid in the battery pack according to the first example of the present disclosure;

FIG. 6 is a plan view illustrating an upper cover, a lower cover, and a distribution member of a battery pack according to a second example of the present disclosure;

FIG. 7 is a view illustrating a temperature distribution of a cooling fluid in the battery pack according to the second example of the present disclosure;

FIG. 8 is a plan view illustrating an upper cover, a lower cover, and a distribution member of a battery pack according to a third example of the present disclosure;

FIG. 9 is a view illustrating a temperature distribution of a cooling fluid in the battery pack according to the third example of the present disclosure;

FIG. 10 is a plan view illustrating an upper cover, a lower cover, and a distribution member of a battery pack according to a fourth example of the present disclosure;

FIG. 11 is a view illustrating a temperature distribution of a cooling fluid in the battery pack according to the fourth example of the present disclosure;

FIG. 12 is a view illustrating a temperature distribution of a cooling fluid in a battery pack according to a first comparative example;

FIG. 13 is a view illustrating a temperature distribution of a cooling fluid in a battery pack according to a second comparative example;

FIG. 14 is a view illustrating a temperature distribution of a cooling fluid in a battery pack according to a third comparative example; and

FIG. 15 is a view illustrating a temperature distribution of a cooling fluid in a battery pack according to a fourth comparative example.

### DETAILED DESCRIPTION

Hereinafter, a battery pack according to the present disclosure will be described with reference to the accompanying drawings.

### Battery Pack

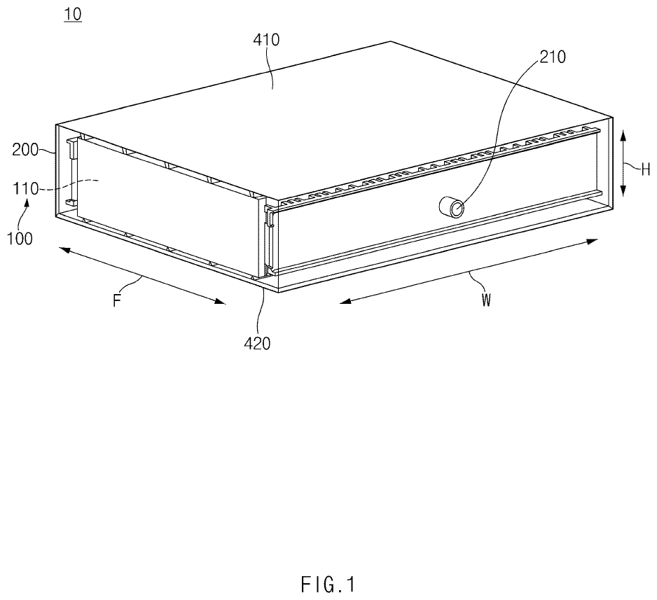

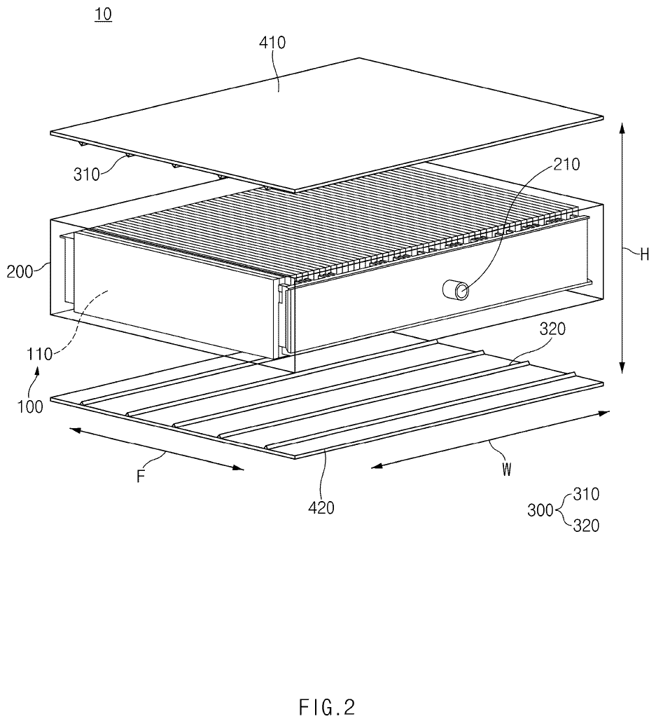

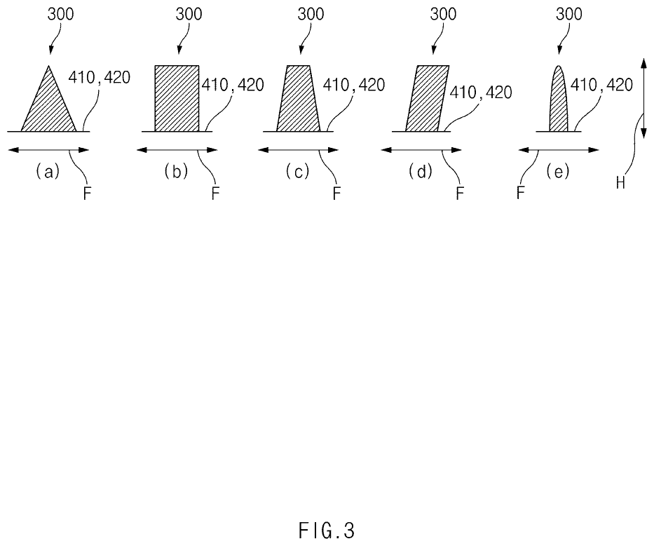

FIG. 1 is a perspective view illustrating a structure of a battery pack according to the present disclosure, and FIG. 2 is a perspective view illustrating a state in which an upper cover and a lower cover are vertically spaced apart from an accommodation member in the battery pack according to the present disclosure. Further, FIG. 3 is a cross-sectional view illustrating examples of a shape of a distribution member provided in the battery pack according to the present disclosure.

Referring to FIGS. 1 to 3, a battery pack 10 according to the present disclosure may include a laminate 100 including an electrode assembly 110 having a structure in which an electrode and a separation membrane are alternately arranged. As an example, as illustrated in FIGS. 1 and 2, the laminate 100 may have a structure in which a plurality of electrode assemblies 110 are stacked in a left-right direction “W”.

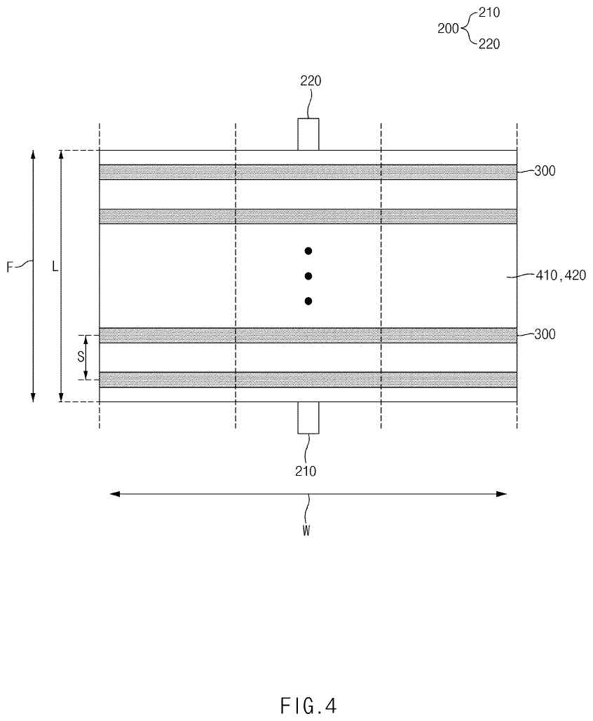

Further, the battery pack 10 may further include an accommodation member 200 that has an inner space in which the laminate 100 is accommodated and includes an inlet 210 provided on a front side thereof in a front-rear direction “F” and an outlet 220 (see FIG. 4) provided on a rear side thereof in the front-rear direction “F”.

The accommodation member 200 may have a top-opened shape or may have a bottom-opened shape. Further, a cross section of the accommodation member 200 in a horizontal direction may have a rectangular shape.

Meanwhile, the laminate 100 provided in the battery pack according to the present disclosure may be cooled by heat exchange with a cooling fluid introduced through the inlet 210, and the cooling fluid heat-exchanged with the laminate 100 may be discharged to the outside through the outlet 220. Meanwhile, the cooling fluid according to the present disclosure is directly in contact with the electrode assembly 110 provided in the laminate 100 and thus may be a fluid having electrical insulation. For example, the cooling fluid introduced into the accommodation member 200 may be oil.

Referring now to FIGS. 1 to 3, the battery pack 10 may include a distribution member 300 spaced upward or downward from the laminate 100. In more detail, the distribution member 300 changes a flow direction of the cooling fluid so that the electrode assemblies 110 may be uniformly cooled regardless of positions of the plurality of electrode assemblies 110 provided in the laminate 100. To this end, according to the present disclosure, the distribution member 300 may have a shape extending in the left-right direction “W” as a lengthwise direction. Further, the distribution member 300 may be provided as a plurality of distribution members 300, and the plurality of distribution members 300 may be spaced apart from each other in the front-rear direction “F” intersecting the left-right direction “W”.

As an example, an electrode tab provided in the electrode assembly 110 may be provided to face a front surface and a rear surface of the accommodation member 200. When the cooling fluid is introduced through the inlet 210, a portion of the cooling fluid collides with the electrode tab facing the front surface of the accommodation member 200 and then moves in the left-right direction “W”. In this case, since the cooling fluid continuously moves in the left-right direction “W” without a separate obstacle, the cooling fluid introduced into the accommodation member 200 through the inlet 210 is largely introduced into i) a center area of the accommodation member 200 in the left-right direction “w” and ii) left and right ends of the accommodation member 200 in the left-right direction “W”.

However, according to the present disclosure, since the distribution member 300 extending in the left-right direction “W” is formed, the cooling fluid collides with the distribution member 300 again while moving rearward in the front-rear direction “F”. Accordingly, since the cooling fluid is spread in the left-right direction “W”, the cooling fluid may be uniformly in contact with all the electrode assemblies 110 provided in the laminate 100. Thus, according to the present disclosure, when the battery pack is relatively large as compared to a battery module, the electrode assembly may be uniformly cooled.

Referring now to FIGS. 1 and 2, the battery pack 10 according to the present disclosure may include an upper cover 410 that is coupled to the accommodation member 200 and covers an upper area of the accommodation member 200. In this case, the distribution member 300 may include an upper distribution member 310 fixed to a lower surface of the upper cover 410 and protruding downward. In this case, with regard to the distribution member 300, the upper distribution member 310 may have a shape extending in the left-right direction “W” as the lengthwise direction, and the upper distribution member 310 may be provided as a plurality of upper distribution members 310 which are spaced apart from each other in the front-rear direction “F”.

Further, the battery pack 10 may further include a lower cover 420 that is coupled to the accommodation member 200 and covers a lower area of the accommodation member 200. In this case, the distribution member 300 may include a lower distribution member 320 fixed to a upper surface of the lower cover 420 and protruding upward. In this case, with regard to the distribution member 300, the lower distribution member 320 may have a shape extending in the left-right direction “W” as the lengthwise direction, and the lower distribution member 320 may be provided as a plurality of lower distribution members 320 which are spaced apart from each other in the front-rear direction “F”.

Hereinafter, referring to FIG. 3, the shape of the distribution member 300 will be described. It is apparent that the following description related to a cross section of the distribution member 300 may be equally applied to the upper distribution member 310 and the lower distribution member 320.

Referring to FIG. 3A, when the distribution member 300 is cut in a vertical direction “H” (see FIG. 1), the distribution member 300 may have a triangular shape. For example, the cross section of the distribution member 300 in the vertical direction “H” may have an isosceles triangular shape.

Further, referring to FIGS. 3B to 3D, when the distribution member 300 is cut in the vertical direction “H” (see FIG. 1), the distribution member 300 may have a quadrangular shape. For example, as illustrated in FIG. 3B, the cross section of the distribution member 300 in the vertical direction “H” may have a rectangular shape, as illustrated in FIG. 3C, the cross section of the distribution member 300 in the vertical direction “H” may have an isosceles trapezoidal shape, and as illustrated in FIG. 3D, the cross section of the distribution member 300 in the vertical direction “H” may have a parallelogram shape. When the cross section of the distribution member 300 in the vertical direction “H” has a parallelogram shape, the distribution member 300 may have a shape inclined forward as it becomes closer to the laminate 100 (see FIG. 1). This may be for smooth flow of the cooling fluid.

Meanwhile, as illustrated in FIGS. 3A, 3C, and 3E, when the distribution member 300 is cut in the vertical direction “H” (see FIG. 3), the distribution member 300 may have a shape in which a width in the front-rear direction “F” (see FIG. 1) decreases as it becomes closer to the laminate 100 (see FIG. 1).

Meanwhile, as illustrated in FIGS. 3B and 3D, when the distribution member 300 is cut in the vertical direction “H” (see FIG. 1), the distribution member 300 may also have a shape having a constant width in the front-rear direction “F”.

Further, as illustrated in FIG. 3E, when the distribution member 300 is cut in the vertical direction “H”, the distribution member 300 may include a curved surface convexly protruding in the front-rear direction “F”.

Meanwhile, according to the present disclosure, the upper cover 410 and the upper distribution member 310 may be formed integrally, and the lower cover 420 and the lower distribution member 320 may be formed integrally.

Meanwhile, in the battery pack 10 according to the present disclosure, intervals between the distribution members 300 may be formed differently according to the relative positions of the inlet 210 and the outlet 220.

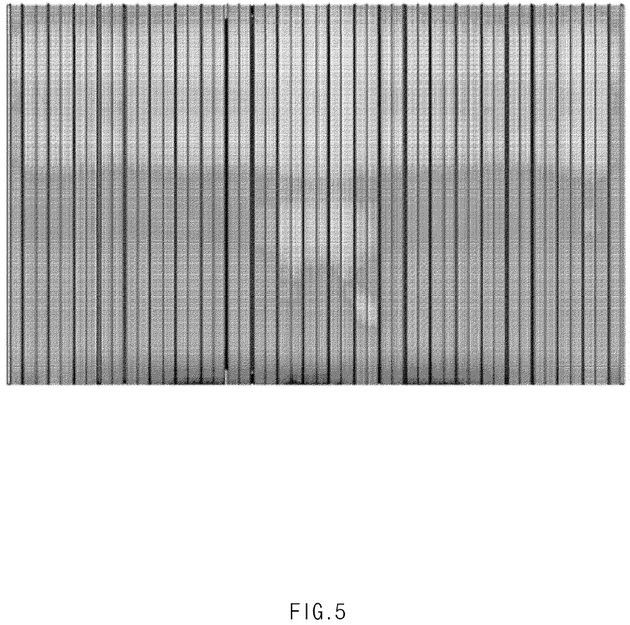

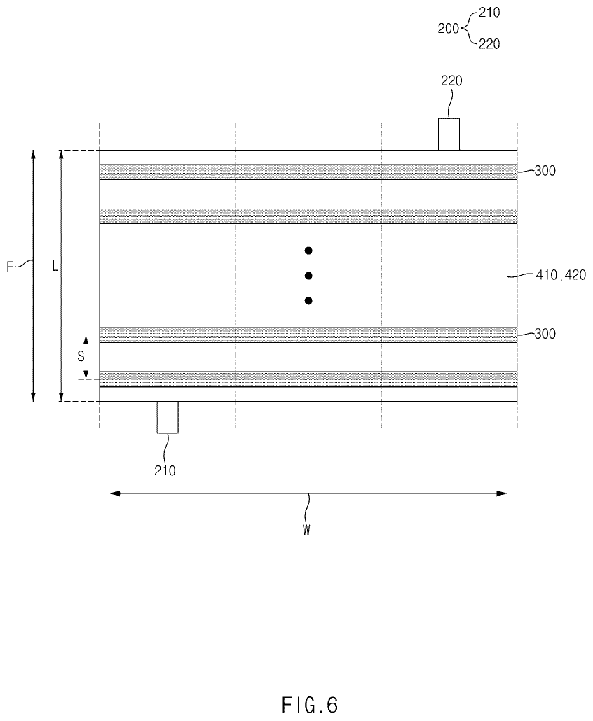

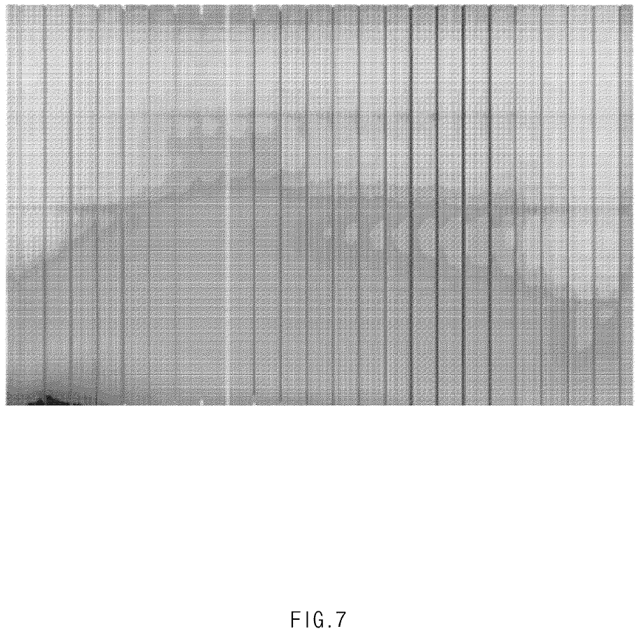

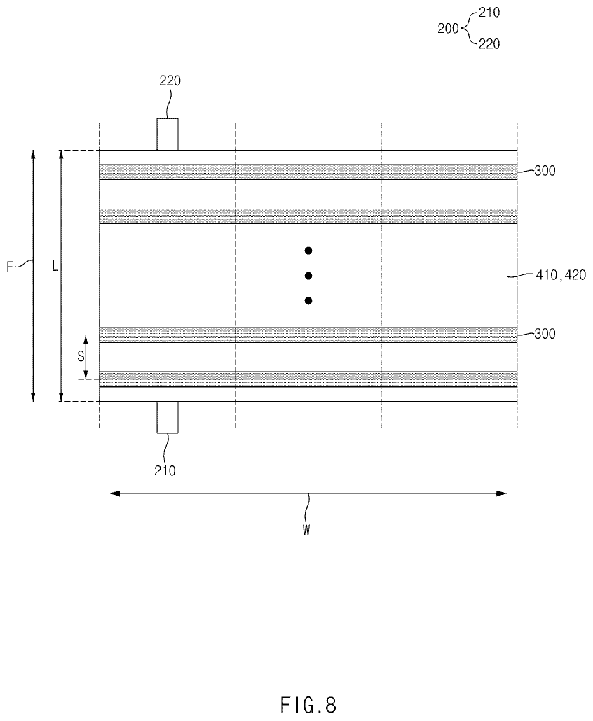

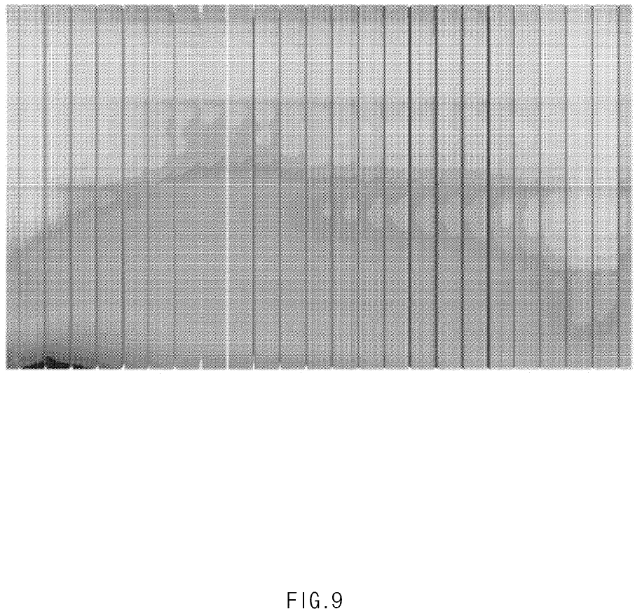

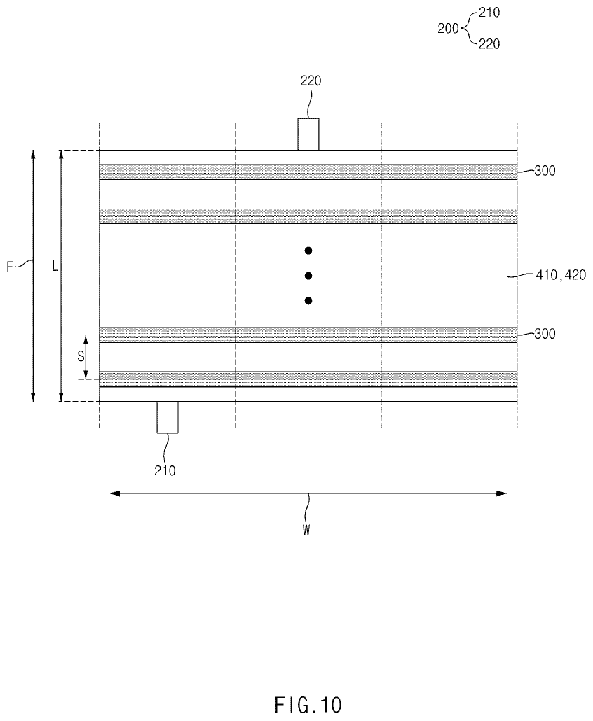

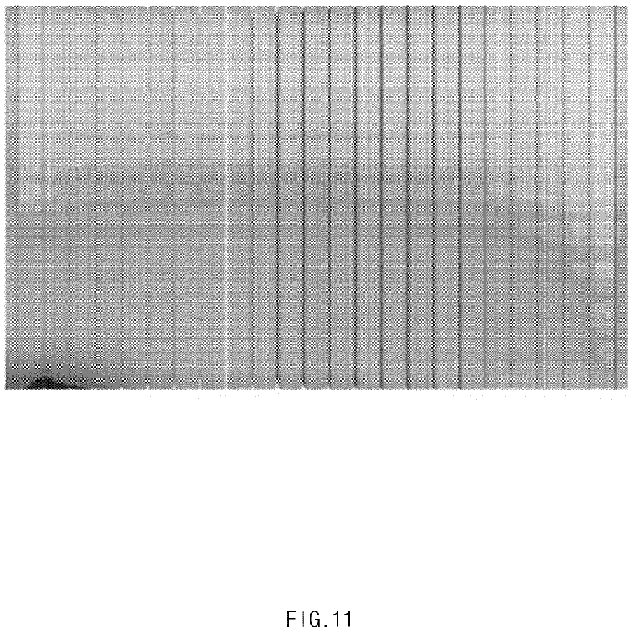

FIG. 4 is a plan view illustrating an upper cover, a lower cover, and a distribution member of a battery pack according to a first example of the present disclosure, and FIG. 5 is a view illustrating a temperature distribution of a cooling fluid in the battery pack according to the first example of the present disclosure. FIG. 6 is a plan view illustrating an upper cover, a lower cover, and a distribution member of a battery pack according to a second example of the present disclosure, and FIG. 7 is a view illustrating a temperature distribution of a cooling fluid in the battery pack according to the second example of the present disclosure. FIG. 8 is a plan view illustrating an upper cover, a lower cover, and a distribution member of a battery pack according to a third example of the present disclosure, and FIG. 9 is a view illustrating a temperature distribution of a cooling fluid in the battery pack according to the third example of the present disclosure. FIG. 10 is a plan view illustrating an upper cover, a lower cover, and a distribution member of a battery pack according to a fourth example of the present disclosure, and FIG. 11 is a view illustrating a temperature distribution of a cooling fluid in the battery pack according to the fourth example of the present disclosure.

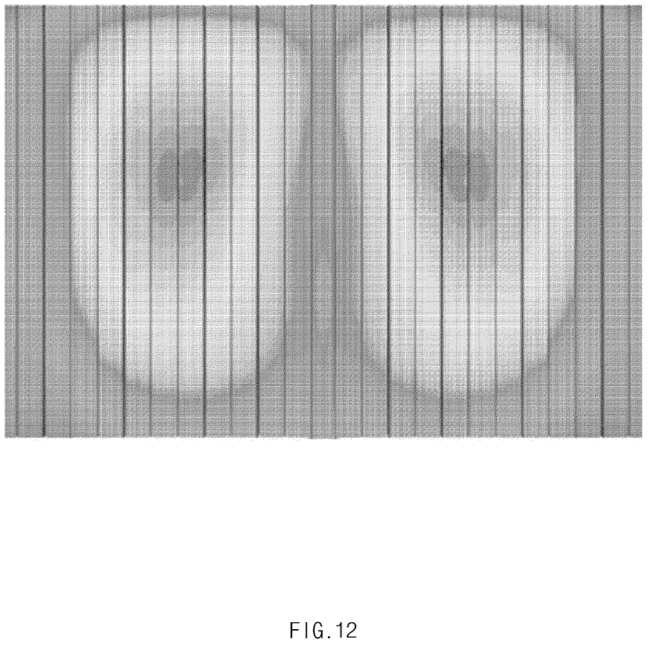

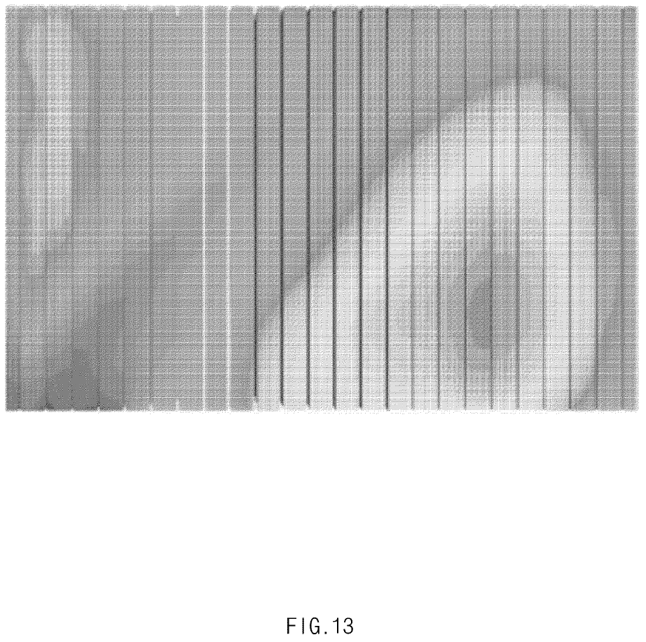

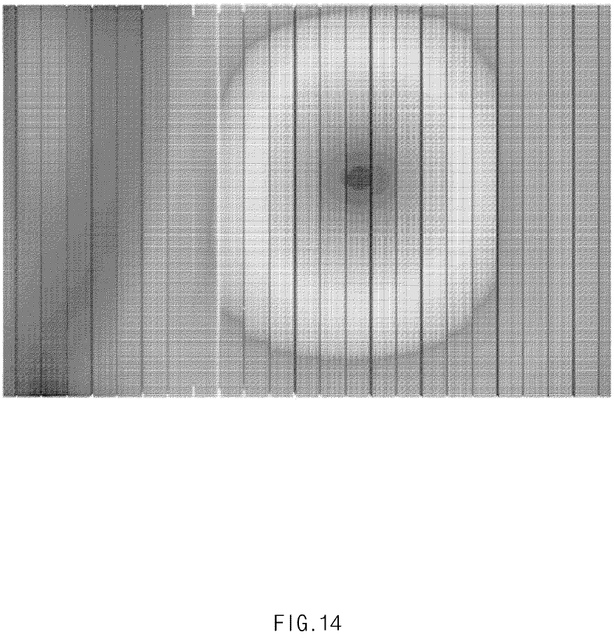

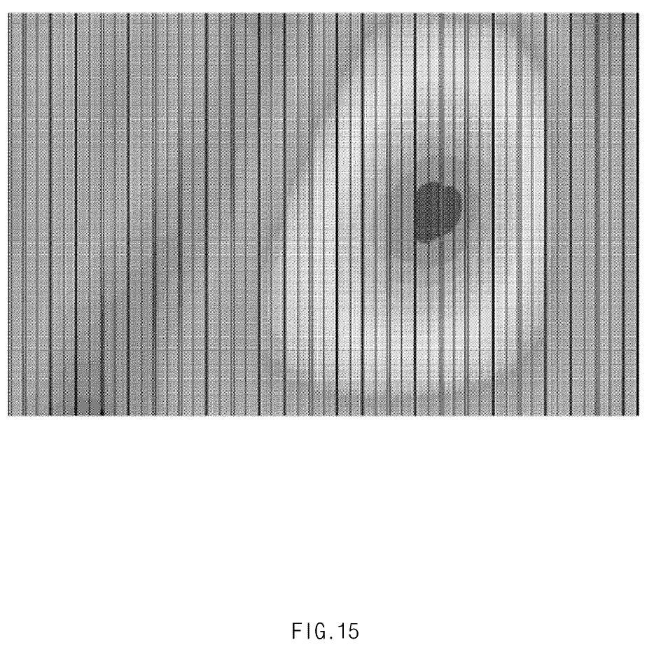

FIG. 12 is a view illustrating a temperature distribution of a cooling fluid in a battery pack according to a first comparative example, and FIG. 13 is a view illustrating a temperature distribution of a cooling fluid in a battery pack according to a second comparative example. FIG. 14 is a view illustrating a temperature distribution of a cooling fluid in a battery pack according to a third comparative example, and FIG. 15 is a view illustrating a temperature distribution of a cooling fluid in a battery pack according to a fourth comparative example.

Meanwhile, the inlet 210 and the outlet 220 are provided in the accommodation member 200. However, for convenience of description of the intervals between the distribution members 300 according to the relative positions of the inlet 210 and the outlet 220, FIGS. 4, 6, 8, and 10 illustrate that the inlet 210 and the outlet 220 protrudes from either the upper cover 410 or the lower cover 420.

Referring to FIG. 4, according to the first example, the inlet 210 and the outlet 220 may be provided at a center of the accommodation member 200 (see FIG. 1) in the left-right direction “W”, and a ratio s/L of an interval “s” between the plurality of distribution members 300 in the front-rear direction “F” to a length “L” of the upper cover 410 or the lower cover 420 in the front-rear direction “F” may be 0.02 or more and 0.24 or less. In more detail, when s/L is greater than 0.24, the cooling fluid is not uniformly spread in the left-right direction “W”, and thus it is difficult to implement uniform cooling of the electrode assembly. On the other hand, when s/L is less than 0.02, it is difficult to form the upper distribution member 310 or the lower distribution member 320 on the upper cover 410 or the lower cover 420 in terms of manufacturing. That is, according to the first example, when s/L is 0.02 or more and 0.24 or less, convenience in manufacturing may be secured even while the uniform cooling of the electrode assembly may be implemented. More preferably, in the first example of the present disclosure, s/L may be 0.20 or more and 0.24 or less.

As illustrated in FIG. 5, according to the first example of the present disclosure, it may be identified that, when the distribution member 300 is provided in the battery pack 10, a temperature is uniform in the entire area of the accommodation member 200. On the other hand, as illustrated in FIG. 12, it may be identified that, when the battery pack has the same structure as that according to the first example of the present disclosure but the distribution member is not provided, the temperature is remarkably high in an area between a central area in the left-right direction and one end and an area between the central area in the left-right direction and the other end.

Meanwhile, referring to FIG. 6, according to the second example, the inlet 210 may be provided at a position at which a ratio of a distance from one end of the accommodation member 200 (see FIG. 1) in the left-right direction “W” to a distance from the other end thereof in the left-right direction “W” is 1:5, the outlet 220 may be provided at a position at which a ratio of a distance from the one end of the accommodation member 200 (see FIG. 1) in the left-right direction “W” to a distance from the other end thereof in the left-right direction “W” is 5:1, and a ratio s/L of the interval s between the plurality of distribution members 300 in the front-rear direction “F” to the length “L” of the upper cover 410 or the lower cover 420 in the front-rear direction “F” may be 0.02 or more and 0.20 or less. In more detail, when s/L is greater than 0.20, the cooling fluid is not uniformly spread in the left-right direction “W”, and thus it is difficult to implement uniform cooling of the electrode assembly. On the other hand, when s/L is less than 0.02, it is difficult to form the upper distribution member 310 or the lower distribution member 320 on the upper cover 410 or the lower cover 420 in terms of manufacturing. That is, according to the second example, when s/L is 0.02 or more and 0.20 or less, convenience in manufacturing may be secured even while the uniform cooling of the electrode assembly may be implemented. More preferably, in the second example of the present disclosure, s/L may be 0.17 or more and 0.24 or less.

As illustrated in FIG. 7, according to the second example of the present disclosure, it may be identified that, when the distribution member 300 is provided in the battery pack 10, a temperature is uniform in the entire area of the accommodation member 200. On the other hand, as illustrated in FIG. 13, it may be identified that when the battery pack 10 has the same structure as that according to the second example of the present disclosure but the distribution member 300 is not provided, the temperature of one area in the left-right direction is significantly higher than that of the other area.

Meanwhile, referring to FIG. 8, according to the third example, the inlet 210 and the outlet 220 may be provided at a position at which the ratio of the distance from the one end of the accommodation member 200 (see FIG. 1) in the left-right direction “W” to the distance from the other end thereof in the left-right direction “W” is 1:5, and the ratio s/L of the interval “s” between the plurality of distribution members 300 in the front-rear direction “F” to the length “L” of the upper cover 410 or the lower cover 420 in the front-rear direction “F” may be 0.02 or more and 0.17 or less. In more detail, when s/L is greater than 0.17, the cooling fluid is not uniformly spread in the left-right direction “W”, and thus it is difficult to implement uniform cooling of the electrode assembly. On the other hand, when s/L is less than 0.02, it is difficult to form the upper distribution member 310 or the lower distribution member 320 on the upper cover 410 or the lower cover 420 in terms of manufacturing. That is, according to the third example, when s/L is 0.02 or more and 0.17 or less, convenience in manufacturing may be secured even while the uniform cooling of the electrode assembly may be implemented.

As illustrated in FIG. 9, according to the third example of the present disclosure, it may be identified that, when the distribution member 300 is provided in the battery pack 10, a temperature is uniform in the entire area of the accommodation member 200. On the other hand, as illustrated in FIG. 14, it may be identified that when the battery pack 10 has the same structure as that according to the third example of the present disclosure but the distribution member 300 is not provided, the temperature of one area in the left-right direction is significantly higher than that of the other area.

Meanwhile, referring to FIG. 10, according to the fourth example, the inlet 210 may be provided at a position at which a ratio of a distance from one end of the accommodation member 200 (see FIG. 1) in the left-right direction “W” to a distance from the other end thereof in the left-right direction “W” is 1:5, the outlet 220 may be provided at a center of the accommodation member 200 (see FIG. 1) in the left-right direction “W”, and a ratio s/L of the interval s between the plurality of distribution members 300 in the front-rear direction “F” to the length “L” of the upper cover 410 or the lower cover 420 in the front-rear direction “F” may be 0.02 or more and 0.24 or less. In more detail, when s/L is greater than 0.24, the cooling fluid is not uniformly spread in the left-right direction “W”, and thus it is difficult to implement uniform cooling of the electrode assembly. On the other hand, when s/L is less than 0.02, it is difficult to form the upper distribution member 310 or the lower distribution member 320 on the upper cover 410 or the lower cover 420 in terms of manufacturing. That is, according to the fourth example, when s/L is 0.02 or more and 0.24 or less, convenience in manufacturing may be secured even while the uniform cooling of the electrode assembly may be implemented. More preferably, in the fourth example of the present disclosure, s/L may be 0.20 or more and 0.24 or less.

As illustrated in FIG. 11, according to the fourth example of the present disclosure, it may be identified that, when the distribution member 300 is provided in the battery pack 10, a temperature is uniform in the entire area of the accommodation member 200. On the other hand, as illustrated in FIG. 15, it may be identified that when the battery pack 10 has the same structure as that according to the fourth example of the present disclosure but the distribution member 300 is not provided, the temperature of one area in the left-right direction is significantly higher than that of the other area.

According to the present disclosure, there may be provided a battery pack having a novel structure, which may implement immersion cooling without configuring a plurality of battery modules.

As described above, although the present disclosure has been described with reference to the limited embodiments and drawings, the present disclosure is not limited thereto. It is apparent that those skilled in the art to which the present disclosure belongs could derive various implementations without departing from the technical spirit of the present disclosure and the equivalents of the appended claims.

What is claimed is:

1. A battery pack comprising:
a laminate including a plurality of electrode assemblies each having a structure in which an electrode and a separation membrane are alternately arranged, the plurality of electrode assemblies being laminated in a first direction;
an accommodation member having an inner space in which the laminate is accommodated and including an inlet provided on one side thereof, through which a cooling fluid is introduced, and an outlet provided on another side thereof, through which the cooling fluid is discharged, the another side opposing the one side in a second direction crossing the first direction; and
a distribution member spaced from the laminate in a third direction crossing the first direction and the second direction and configured to change a flow direction of the cooling fluid,
wherein the distribution member has a shape extending in the one direction.

2. The battery pack of claim 1, wherein the accommodation member has an open upper area,
the battery pack further includes an upper cover coupled to the accommodation member and configured to cover the upper area, and
the distribution member includes an upper distribution member fixed to a lower surface of the upper cover and protruding downward towards the laminate.

3. The battery pack of claim 2, wherein the accommodation member has an open lower area,
the battery pack further includes a lower cover coupled to the accommodation member and configured to cover the lower area, and
the distribution member includes a lower distribution member fixed to an upper surface of the lower cover and protruding upward towards the laminate.

4. The battery pack of claim 3, wherein the distribution member is provided as a plurality of distribution members, and
the plurality of distribution members are spaced apart from each other in the second direction.

5. The battery pack of claim 4, wherein the inlet and the outlet are provided at a center of the accommodation member in the first direction, and
a ratio s/L of an interval “s” between the plurality of distribution members in the second direction to a length “L” of the upper cover or the lower cover in the second direction is 0.02 or more and 0.24 or less.

6. The battery pack of claim 4, wherein the inlet is provided at a position at which a ratio of a distance from one end of the accommodation member in the first direction to a distance from the other end thereof in the first direction is 1:5,
the outlet is provided at a position at which a ratio of the distance from the one end of the accommodation member in the first direction to the distance from the other end thereof in the first direction is 5:1, and
a ratio s/L of an interval “s” between the plurality of distribution members in the second direction to a length “L” of the upper cover or the lower cover in the second direction is 0.02 or more and 0.20 or less.

7. The battery pack of claim 4, wherein the inlet and the outlet are provided at a position at which a ratio of a distance from one end of the accommodation member in the first direction to a distance from the other end thereof in the first direction is 1:5, and
a ratio s/L of an interval “s” between the plurality of distribution members in the second direction to a length “L” of the upper cover or the lower cover in the second direction is 0.02 or more and 0.17 or less.

8. The battery pack of claim 4, wherein the inlet is provided at a position at which a ratio of a distance from one end of the accommodation member in the first direction to a distance from the other end thereof in the first direction is 1:5,
the outlet is provided at a center of the accommodation member in the first direction, and
a ratio s/L of an interval “s” between the plurality of distribution members in the second direction to a length “L” of the upper cover or the lower cover in the second direction is 0.02 or more and 0.24 or less.

9. The battery pack of claim 3, wherein the lower cover and the lower distribution member are integral.

10. The battery pack of claim 2, wherein the upper cover and the upper distribution member are integral.

11. The battery pack of claim 1, wherein in a second direction-third direction cross-section, the distribution member has a triangular shape.

12. The battery pack of claim 1, wherein in a second direction-third direction cross-section, the distribution member has a quadrangular shape.

13. The battery pack of claim 1, wherein in a second direction-third direction cross-section, the distribution member has a shape in which a width in the second direction decreases in a direction towards the laminate.

14. The battery pack of claim 1, wherein in a second direction-third direction cross-section, the distribution member has a shape in which a width in the second direction is constant.

15. The battery pack of claim 1, wherein in a second direction-third direction cross-section, the distribution member includes a curved surface convexly protruding in the second direction.
